(19) United States
(12) Patent Application Publication
(10) Pub. No.: US 2008/0120592 A1
(43) Pub. Date: May 22, 2008

(54) Middleware framework

(76) Inventors: Donald O. Tanguay, Sunnyvale, CA (US); Daniel G. gelb, Redwood City, CA (US); Michael L. Harville, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/590,125

(22) Filed: Oct. 31, 2006

(51) Int. Cl. G06F 9/44

(52) U.S. Cl. 717/104

(57) ABSTRACT

A method is described herein for providing a middleware framework in a multiprocessing environment having multiple processing units for developing a desired application. The method includes: receiving a selection of a plurality of task modules for developing the desired application; receiving connections between the selected task modules to form the desired application; receiving an input of a plurality of execution threads for processing through the formed application; and providing automatic global scheduling over the entire middleware framework of the plurality of execution threads by at least a) providing a job list of at least one job for execution by at least one of the plurality of execution threads, each of the at least one job is a processing of one or more data objects by an associated one of the selected task modules, and b) automatically scheduling an execution of each job in the job list by one of the plurality of execution threads based on at least one predetermined policy.

### BACKGROUND

Building robust systems for real-time streaming multimedia applications is difficult because such applications require processing of multiple data streams while maintaining performance and responsiveness. Thus, an application developer must overcome at least four types of challenges: 1) isolating and managing the complexity of the system; 2) supporting concurrent execution on multiple data formats for multimedia applications; 3) operating on sequences of data for data streaming operations; and 4) delivering responsive performance on variable-strength platforms under varying loads for real-time applications.

### BRIEF DESCRIPTION OF THE DRAWINGS

Embodiments are illustrated by way of example and not limited in the following figure(s), in which like numerals indicate like elements, in which:

FIG. 1A illustrates a methodology for software development, in accordance with one embodiment of the present invention.

FIG. 1B illustrates the operations of a global scheduler, in accordance with one embodiment of the present invention.

FIG. 2 illustrates a process flow for a dataflow analysis of an application, in accordance with one embodiment of the present invention.

FIGS. 3A-3C illustrates the decomposition, composition, and runtime management of an application in middleware framework, in accordance with one embodiment of the present invention.

FIG. 4 illustrates an example of using a dataflow middleware framework to build a desired application, in accordance with one embodiment of the present invention.

FIG. 5 illustrates an implementation hierarchy of a dataflow middleware framework, in accordance with one embodiment of the present invention.

FIG. 6 illustrates a block diagram of a computerized system 600 for implementing a dataflow middleware framework, in accordance with one embodiment of the present invention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

The development of real-time multimedia or other complex applications can be greatly accelerated by the use of a middleware framework that abstracts operating system dependencies and provides optimized implementations of frequently used components. Accordingly, described herein are methods and systems for such a middleware framework. In one embodiment of the present invention, there is provided a dataflow middleware (DM) framework that is a multi-platform software framework operable to improve software design of complex applications, such as multimedia applications, by simplifying software design and building and decreasing software development time. Furthermore, the middleware framework is operable to efficiently support complex operations during run-time, either in real-time or off-line.

Most prior solutions to using a DM framework are either single-threaded or thread-per-module, and without use of any global scheduler for multi-threaded execution of the media pipeline. In the single-threaded solutions, the conventional framework delivers a modularity benefit but with lower performance because the execution of modules cannot occur in parallel. In thread-per-module solutions, the application uses parallel execution; however, the application modules must individually react to overflow and starvation situations, and locally decide when to drop media or adjust their operation speed. Accordingly, at least one embodiment of the present invention seeks to provide a simplified modular, dataflow-style design of application software without sacrificing application performance. In a dataflow design, the application is a connected network of functional modules linked together by directed arcs. The dataflow design is well-suited for representing complex applications such as streaming multimedia applications because the modularity reduces complexity, the arcs represent streams of data, and the arcs can transmit multiple data formats. In another embodiment of the present invention, there is provided a middleware framework that includes a global scheduler to automate or orchestrate parallel executions of application tasks across a multiprocessing environment having multiple processors, within a multi-core processor, or across multiple multi-core processors. As referred herein, a processing unit is a single processor or a core of a multi-core processor. Thus, an environment having multiple processors, a multi-core processor, or multiple multi-core processors would have multiple processing units.

Although it is possible to overcome the first three of the aforementioned challenges often faced by a application developer, especially with the aid of modern object-oriented programming languages, the fourth challenge of real-time processing is much more difficult. Thus, while any application is always responsive on an over-powered machine (e.g., webcam video capture using a server-class machine), one or more embodiments of the present invention seek to leverage a machine's multiprocessing capability to deliver application performance even when the machine is resource-limited.

According to another embodiment of the present invention, a DM framework is employed to design and code application software by isolating the algorithms (e.g., video processing or analysis) from the runtime system (e.g., multithreading, synchronization). This enables the application developer to concentrate on the algorithmic processing specific to the application at hand, while at the same time leveraging the framework to overcome the aforementioned challenges often faced by application developers. In addition, such a DM framework provides other software engineering benefits, like improved writability and readability (which simplifies maintenance), code reuse to leverage the work of others, better testing methodologies to simplify debugging and ensure software robustness, and increased portability to other platforms.

Methodology

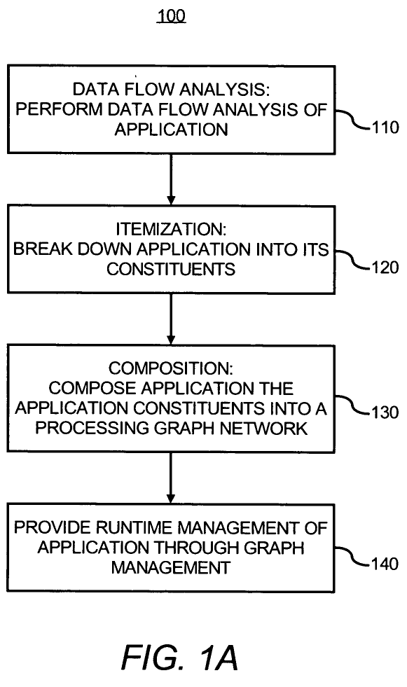

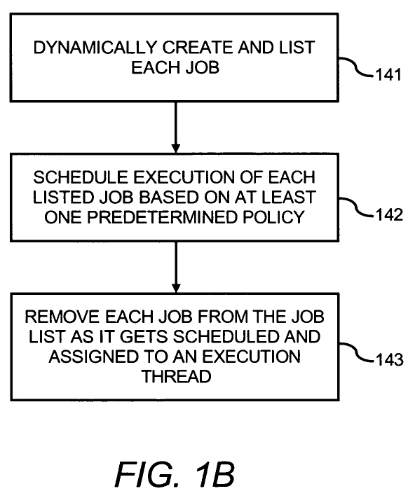

For those embodiments of the present invention that are based on the dataflow paradigm, data from an application flows through a directed graph of computational modules in the DM framework. Thus, in order to create, build, or develop applications in this paradigm, a methodology for software development is adopted to include the following phases: (1) dataflow analysis of the application to determine the signals and processing phases on those signals, (2) decomposition of the application into media representations and processing modules, (3) composition of the modules into a directed graph network, and (4) runtime management of the application graph network. FIG. 1A illustrates the aforementioned methodology 100, which are further described below with details on how a DM framework is operable to aid the methodology.

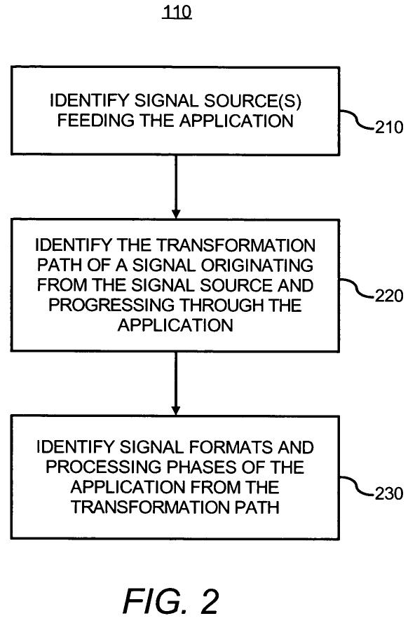

At 110, a dataflow analysis of a target application to be built or developed, such as a streaming media application, is performed. The target application may be in its prototyping or testing phase, wherein an application developer wishes to further analyze the application for further modification or enhancement in order to finalize the target application. FIG. 2 illustrates the details of the phase 110, which may be performed by the application developer. The basic information content in any application is a data signal (e.g., audio or video) that evolves over time. Thus, at 210, to perform a dataflow analysis of the application, the application developer first identifies one or more signal sources (e.g., microphone, camera, or file) that feed the application. Next, at 220, the application developer follows the desired transformation path of each signal as it progresses through the application from its origination at a signal source. Between each identifiable signal format along this transformation path, the signal undergoes a distinct phase of processing. For example, an audio signal may begin its existence in PCM format at the microphone source, then undergo transformations into ADPCM, and then into UDP packets. In this example, the compression stage lies between the PCM and ADPCM formats, and the network packetization stage lies between the ADPCM and UDP formats. Transformations of the signal may also occur during processing stages that do not alter the format of the signal. For example, a color correction stage may produce image output with the same format as its image input, but with modified data internal to the images. Thus, at 230, by analyzing each signal in this manner, the application developer is able to identify both the signal formats and the different processing phases of the application.

Referring back to FIG. 1A, the next phase in the methodology 100 is application itemization at 120, wherein the application developer breaks down the application to be built into its constituents or components based on the dataflow analysis. The earlier identified signal formats are media types, and the earlier identified processing phases operate on those media types. In one embodiment, the DM framework provides three abstractions to support this itemization phase: media objects, task objects, and jobs. As referred herein, media objects are the basic units of data, each unit being of a particular media type. Each media object can be any type of data signal, such as a stream-based signal in a multimedia application. Examples of a stream-based signal include but are not limited to an audio stream, video stream, and a stream of two-dimensional (2D) coordinates of a face in each of a series of images. In contrast, as referred herein, task objects are basic units of processing. Each task object has zero or more inputs for receiving one or more media objects, zero or more outputs for sending out one or more media objects to one or more other task objects, or at least one input or one output for receiving and sending one or more media objects. A task object that has at least one output but no input is a source task object, acting as a source of media object(s) such as a production task module described later. A task object that has at least one input but no output is a sink task object, acting as a terminating point for any input media object. For example, a sink task object does not have any output because it does not send out media objects to other task objects in the framework. instead, a sink task object such as a file sink task object may write the resulting media object(s) to a storage medium, or a sink task object such as a network task object may send the resulting media object(s) across a network. A task object can be any type of media computation, such as video compression, video decompression, or face recognition. A task object can also include the generation or consumption of media by I/O processes, such as image capture from a camera or audio playback by a computer sound card and speakers. As also referred herein, a job is a processing of one or more requisite media object(s) by a task object associated with such a job. Thus, one or more jobs may be associated with a particular task and a particular media object(s). Furthermore, multiple jobs may be processed by a single task object, sequentially over time or simultaneously depending on the type of the task object.

For each unique signal format, the application developer may define a separate media type for media objects, inheriting from a Media base class for object-oriented programming such behaviors as timestamp recording, memory management, and automatic serialization. Likewise, for each processing phase, the developer may use a predetermined task module already available in the DM framework or he may define a new task module that inherits the behavior of the predetermined Task base class for object-oriented programming in the DM framework. Thus, each task module has zero or more input pins, zero or more output pins, or at least one input pin or one output pin to correspond to the input(s) and output(s) of the corresponding task object. Inheritable behaviors for task modules include Input/Output (I/O) buffer management and multithreaded execution and synchronization. The code inside each task module is the algorithmic mapping from inputs to outputs and is isolated from common threading or synchronization issues, made possible from simply using the DM framework.

Referring back to FIG. 1A, the media and task objects and associated jobs are now application building blocks. Thus, at 130, the application developer may form the application to be built through composition of its constituents or components, wherein the application developer connects many task modules (each representing a task) together to form a processing graph network and requests from the DM framework one or more framework threads (hereinafter also referred to as “execution threads”) for execution or performance of one or more jobs in the application or processing graph network. Each connection is a one-way transfer of a particular media type and represents a media stream. Provided that all task pins are connected, the application may start the processing graph network by triggering the production tasks to create media objects. After each production of a media object, a production task may trigger itself to create a next media object. Each media object flows from a media-production task module to the rest of the processing network or graph and further triggers the consumption, production, or processing behavior of the rest of the tasks in the application based on the execution threads.

According to one embodiment, the DM framework also includes an internal memory manager that optimizes reuse of media buffers within the media objects. At a later time, a graphical display program, which is a part of the DM framework as described below, can issue the stop command, causing the framework threads to halt execution of jobs associated with the graph. In some embodiments, the stop command causes all currently scheduled jobs to be executed before a halt to job execution takes effect. Stopping the graph preserves the internal data state of the task modules. In a dynamic application, tasks may be added to or removed from the graph by first stopping the graph, then adding or removing task modules, and then issuing a start command to continue the application with the new graph and with the internal data states of the any task modules that were not removed. Alternatively, the graphical display program may issue a destroy command, which recursively destroys all the Tasks in the graph. Although the aforementioned commands for the DM framework are described with reference to framework commands that may be available through the graphical display program, it should be understood that the framework commands may be issued to the DM framework through mechanisms or commands available outside of the graphical display programs, and automatically within the DM framework or manually by a user input to the DM framework.

Unlike many other architectures, the DM framework supports arbitrary graph topologies, including cycles. Cycles are important in any application with a feedback loop. For example, mouse motion from a display task module may determine a viewpoint for novel view synthesis in another task module, which may in turn send a new image to the display task module. In order to agree on the type of media stream, two connected task modules may have to negotiate the media type. For example, a generalized UDP Task may accept any media type, but the video source feeding it may deliver only MPEG-4 video. Because the UDP Task is flexible, the two task modules simply agree to send/receive the MPEG-4 video media type. In the end, the completed graph structure directly represents the task dependencies of the application.

Referring to FIG. 1A again, at 140, run-time management of the application graph network is provided to the user, such as the application developer. In one embodiment, the DM framework provides a real-time graphical display, for example, via a graphical user interface (GUI) software program, of the processing graph network. Such a display provides the user with a dynamic visualization of the processing graph topologies and the real-time performance statistics of the tasks, including latencies in the application and throughput statistics per task and per application overall. The graphical display enables the user to manage and manipulate the application building or development through graph management of the processing graph network that represents the application. For example, the user can modify the connection(s) to and from one or more task modules in the processing graph network with or without also modifying the internal states therein of the modified task modules. For graph management, at application run-time, once the task modules are connected and the media types are determined for each connection, the application is ready to be executed by the DM framework. Next, the graphical display program therein issues the start command for the application graph, which triggers the operation of a global scheduler within the DM framework. In response, the internal threads of the DM framework traverse the processing graph network, to direct media flow across the task connections, i.e., connections between the task modules, in accordance with predetermined policies set by the global scheduler, and perform available job(s) listed in the global scheduler by processing one or more media objects using one or more task modules.

In one embodiment, the global scheduler automatically employs predetermined policies to manage the defined execution threads that traverse the task modules for executing jobs in the processing graph network based on the chosen connections between the task modules. The global scheduler also keeps track of computational statistics, such as mean latency and throughput for individual tasks and the overall graph of tasks, to identify bottlenecks in application performance. The global scheduler includes a list of jobs for execution by the execution threads. Thus, when an execution thread exits a task module after performing a job, it refers back to the global scheduler to identify the next job in the job list to be performed and proceeds to the associated task module to perform such a job on a set of associated media objects.

FIG. 1B illustrates the operations of the global scheduler in accordance with one embodiment of the present invention.

At 141, the global scheduler dynamically creates and stores each job in its job list. For example, when those data objects desired or needed by a task module become available for the task module, a job is created and listed for execution by such a task module. In another example, a job may be dynamically created and listed when a job is desired at a source task module (with no input pin), for example, to generate media objects or other data objects for processing by other task modules in the DM framework.

At 142, the global scheduler automatically schedules the execution of each job in its job list based on one or more predetermined policies. The automatic scheduling includes assignment of each listed job to a particular execution thread.

At 143, the global scheduler automatically removes each job from the job list once it is assigned to an execution thread so as to avoid a job being assigned to different execution threads. Accordingly, the operation of the global scheduler based on its own predetermined policies is automatic and transparent to the application developer. The predetermined policies of the global scheduler are further described below.

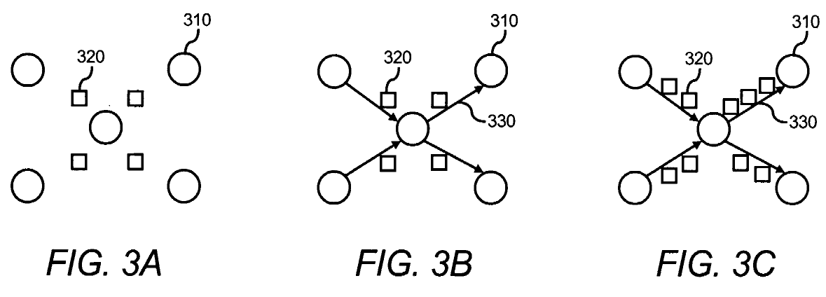

FIGS. 3A-C provide graphical illustrations of the application and its constituents as it goes through the last three phases (decomposition, composition, and graph management) of the methodology 100, in accordance with one embodiment of the present invention. In FIG. 3A, after dataflow analysis, the application is decomposed into its constituent tasks and signals, as shown by the five processing tasks 310 and four signal formats 320. In FIG. 3B, the task dependencies, as shown by the arrows 330, are then made explicit during composition of the tasks into a task structure. Finally, in FIG. 3C, the application is executed by managing the completed task graph through management of the flow of signals across the task connections 330.

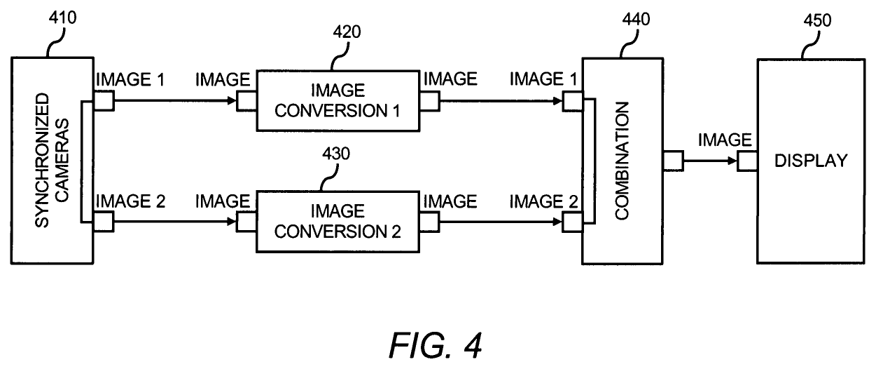

FIG. 4 illustrates an example of using the DM framework to build or develop a desired application. First, the signal sources, such as synchronized cameras, 410 are identified. Next, various task modules 420-450 are instantiated for the desired application. Then the signal sources 410 and the task modules 420-450 are connected to form a single application graph, or processing graph network. Then, the graph is managed through simple graph commands, such as start, stop, and destroy.

Framework

According to one embodiment of the present invention, the DM framework is a computing service by design, and it is modeled on an execution environment in a single computing machine, such as a computer. With such a model, it is assumed that the DM framework has control of the computing resources on a machine. In other words, the DM framework does not compete for CPU resources through the vagaries of an Operating System (OS) scheduler of the machine. Of course, in a typical non-real-time operating system, this assumption is not met due to preemption by normal OS operations. However, by using the DM framework to implement all compute-intensive applications on a particular machine, it has been determined that such assumption is a reasonable approximation.

Because external processes do not affect the framework performance, it is also reasonable to expect that the framework does not affect external processes either. This clean separation is possible by dividing the processes (in application processing phases) into two categories: computing and I/O. Computing processes take significant time and are throughput-sensitive. For example, a video codec may have a significant latency, but performance is good if it can maintain a frame-rate of 30 Hz. I/O processes, on the other hand, require less time to handle but are latency-sensitive. For example, drawing a window at a new location is relatively quick to do, but if there was a delay in performing this task, a user would notice. A similar argument applies to playing audio on an output device or capturing strokes on a keyboard. Therefore, I/O operations (e.g., listening to camera devices or handling window events) are carefully left to the native platform or OS on the machine, and the task modules in the DM framework become computation modules without any I/O processing capability. This separation of processing into computing and I/O tasks translates into two other assumptions: the DM framework is not competing against other compute-intensive applications, and the native platform is not competing against the DM framework for I/O responsiveness.

In one embodiment, implementing the aforementioned computation model of the DM framework includes artificially depressing the priority of the framework execution threads. This ensures that the native OS on the machine has I/O responsiveness. Because I/O is quick, the remainder of the CPU time that is not needed for I/O in the machine is given to the framework, which is the only compute-intensive application. In other words, the framework is operable to handle computation while (and only after) the OS and other standard-priority threads handle I/O processes.

In a single-processor scenario for the machine (e.g., the machine having a single processor with a single core), the CPU works on an initial data signal from a signal source and propagates the data signal and its descendent signals through the processing graph network (in any valid order guided by data dependencies) until the wave of signals is entirely consumed. This procedure is repeated similarly on the next initial signal, and so on. If the average arrival rate of the new initial data signals is greater than the average completion rate of each data wave, some initial data signals may be dropped in order for the application to remain current (i.e., to avoid continually falling behind with ever-increasing latency).

In a multiprocessor or multi-core scenario (e.g., the machine having multiple processors, or one or more multi-core processors), potential parallelisms, such as task parallelism and data parallelism, significantly change the dynamic behavior of the application. For task parallelism, each task module is a sequential computation module with its internal state set as a function of a history previous computations. An example of this history is the tracked coordinates of a hand, where the location in the previous frame prunes the search for the location in the current frame. Thus, to allow states of predetermined history, the code in each module is sequentially executed. This implies that only one execution thread may be resident in a particular module at any given instance, which implies that the largest number of “live” execution threads is the number of modules in the graph. In other words, the best parallelism achievable in a processing graph network of sequential modules is task parallelism. That is, a machine with processors equal to the number of modules has reached the limit of usable task parallelism. Accordingly, each sequential module essentially consumes the equivalent of one processor to run only one execution thread therein to perform one job at any given instance, and additional processors no longer improve performance because there is no other execution thread to run. In fact, the overall application throughput is now limited by the latency of the slowest module. It should be noted that even in this situation, embodiments of the invention may shift processing of jobs associated with a given task module to different processing units over time.

Data parallelism, on the other hand, can enjoy linear performance improvement as the number of processors increases. To employ data parallelism in the DM framework, at least one task module is a combinational computation module with its algorithmic code reentered because multiple threads may be executing the code to perform or execute multiple jobs at the same time by multiple processing units. Threads often vary in execution time, and so their outputs may not be in sequence. If the downstream module is combinational, the thread continues to run freely, taking advantage of more data parallelism. However, if the downstream module is sequential, the producing threads must be blocked until the correct sequence is attained on the input buffer of the downstream module.

As noted above, task modules in the DM framework are categorized or specified as combinational or sequential by their temporal dependencies. Combinational modules produce output that is solely a function of the current inputs. In other words, these modules do not have any internal history of previous executions. Thus, combinational modules may have internal states that are not functions of previous computations. Sequential modules, on the other hand, do have internal memory of previous executions, so the output may depend both on the current input and previous inputs. In this situation, the data must arrive at the inputs in the correct order. A sequential module can be converted to a combinational module by transferring the current state to the next execution, achieved by linking an additional output to an additional input. This conversion is useful for exposing more parallelism. Thus, when possible, a large sequential module is decomposed into a combination of a small sequential module and a large combinational module. However, according to one embodiment of the present invention, both combinational and sequential modules are specified and employed in the DM framework for modeling an application because certain sequential modules can never be combinational, and their inherently sequential behavior will always limit the amount of parallelism. Such modules are typically sources (e.g., a module that is triggered by an inherently-sequential input device such as a camera) or sinks (e.g., an audio module that writes speech data into an output buffer).

It should be understood that each sequential or combinational task module may be run or executed by a dedicated processing unit in the multiprocessing environment. For example, processing unit 1 runs task module A, processing unit 2 runs task module B, processing unit 3 runs task module C, and so on. Alternatively, one or more sequential task modules may be run or executed by one processing unit in the multiprocessing environment. For example, processing unit 1 runs task modules A and B, processing unit 2 runs task module C, processing unit 3 runs task modules D, E, and F, and so on. Furthermore, each execution thread, depending on the jobs assigned to it, may employ different processing units in the multiprocessing environment to execute its assigned jobs in one or more task modules over time. For example, a single execution thread may hop processors, may implement different tasks, or may do both over time.

Even within the limits of task parallelism from use of sequential modules, there are many options in choosing which task to execute next. In one embodiment, the global scheduler can implement predetermined policies for jobs that favor minimal end-to-end latency. For example, a policy may be implemented to favor descendants of the oldest initial signal that are still active in the DM framework, regardless of whether the oldest initial signal is still active or already used or destroyed in the DM framework. Thus, jobs that employ those descendant signals are given priority to the execution threads for processing by the task modules in the processing graph network. Accordingly, media objects may be provided with time stamps indicating the time at which they are created by a production (or source) task module so that the DM framework can prioritize jobs that include such objects and their descendants. Alternatively, media objects or task objects may be provided with priority tags or other indicators that enable the global scheduler in the DM framework to prioritize the related jobs based on predetermined policies as noted earlier. For example, audio media objects may be given priority over video media objects, and their priorities are indicated with priority tags or indicators. Once the execution priority of a job is determined from the priority tags or indicators in the associated media objects, such tags or indicators are no longer used for job prioritization.

According to another embodiment, the global scheduler may implement a predetermined policy to favor certain jobs over others based on the underlying tasks. For example, a particular job is given a higher (or lower) priority for performance by an execution thread based on how many other tasks depend on the output of the underlying task of the particular job. Likewise, when a job does not yet have available all requisite inputs for its underlying tasks, for example, because some of the inputs are not available for output by other task modules, the job is given a lower priority for performance. In another example, certain job(s) are given a higher (or lower) priority) based on how long has it been since its underlying task has been executed or scheduled for execution so as to favor (or disfavor) the task, and job(s) therefore, that has been waiting the longest.

According to still another embodiment, the global scheduler may implement a predetermined policy to favor certain jobs over others based on preferences given to execution threads that are executed by the same processing unit or by certain selected processing unit(s). For example, while the global scheduler has one job list for all the execution threads in the DM framework, each of the execution threads maintains a separate job priority listing in the global scheduler for such a job list. The separate job priority listing may be, for example, some weightings of priority each execution thread places on the jobs in the job list. Thus, the priority associated with each job in the same job list is different for each execution thread. Consequently, the global scheduler may improve cache usage and decrease the number of cache misses by setting a job priority listing for a particular execution thread to prioritize execution of the next jobs in the job listing that are set for execution on the same processor as the particular execution thread so as to reduce how often an execution thread jumps to different processors. Thus, by removing some of the sequential constraints as noted above, the global scheduler can take advantage of data parallelism as well. This is particularly important for a module that is a performance bottleneck. Thus, the global scheduler can implement policies that take advantage of data parallelism to enhance the application performance. One of the advantages in data parallelism is that the number of “live” threads does not have to equal to the number of task modules or the number of processing units, such as processors or the number of core in a multi-core processor.

Accordingly, using its global knowledge of all pending processing requests, the global scheduler can make on-the-fly (i.e., real-time), best-effort task prioritization decisions, e.g., decisions about which media object to process next, so as to reduce end-to-end latency and avoid wasted processing on dropped media objects. For example, the global scheduler can provide task scheduling that favors the execution of media objects with the oldest ancestor (i.e., oldest initial signal) in order to minimize end-to-end latency. The real-time monitor tool allows a developer to see statistics of the module performance in order to see latencies in the application and identify bottlenecks in application performance.

Implementation

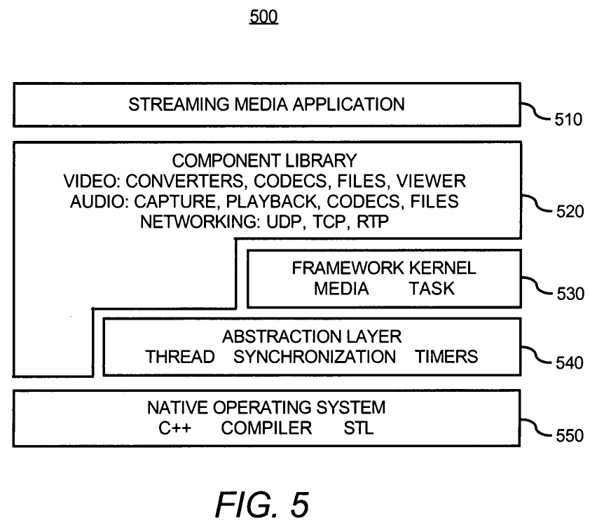

FIG. 5 depicts an implementation hierarchy 500 of the DM framework, which is formed by an abstraction layer 540 and a framework kernel 530, that lies between an application 510 and the native OS 550 of the machine running the application. The abstraction layer 540 insulates the framework kernel 530 from the host platform, as represented by the native OS 550, to keep the framework kernel platform-independent. The component library 520 contains many generically reusable modules. The application developer has access to all levels.

At the lowest level lies the host platform, as represented by the native OS 550, which includes three elements: multithreading support, a timing mechanism, and a programming compiler (e.g., ANSI C++ compiler). Multithreading support includes a thread abstraction for controlling computation as well as the synchronization objects necessary to control the threads. Although the DM framework can operate on a single processor machine, in one embodiment the underlying hardware is a symmetric multiprocessor (SMP) machine in order to benefit from parallel execution or processing. In such a case, the abstraction layer 540 becomes an SMP abstraction layer. A timing mechanism is desired for performance analysis, such as latency measurement. A programming compiler is desired to generate the executables, and such a compiler should have a standard template library (e.g., the C++ Standard Template Library) to allow use of the abstractions (e.g., string, vector, map, set, deque) provided therein throughout the DM framework.

The SMP abstraction layer 540 is the first middle-ware level. It simplifies porting the DM framework to other platforms and operating systems. The Thread abstraction provides the DM framework with the ability to name, spawn, and debug an OS thread. Actual Thread creation is performed with the native platform calls, and each thread may have a log file associated with its unique name, allowing the creation of an execution trace for each thread. The Mutex and Semaphore abstractions enable synchronization of the Threads. Mutex is the standard mutual exclusion object for preventing more than one thread from simultaneous code execution, and Semaphore is a standard, efficient mechanism for signaling between Threads. The StopWatch or Timer abstraction encapsulates the ability to measure time using the platform timing functions. Measuring time is essential to performance analysis.

The second middleware level, the framework kernel 530, implements the core dataflow functionality used by all framework applications. It supplies the extensible Task and Media abstractions for building an application. Internally, the framework kernel also has several abstractions for managing its own complexity. First, the InputPin and OutputPin objects represent the connections between task objects for transferring media objects. Second, the Graph object manages the task objects connected to one another and acts as the interface for graph-wide commands, such as start( ) and stop( ). Graph commands have a single Task argument, but use connectivity to traverse the entire application graph and apply the command to each module in the graph. Third, the memory manager object provides memory buffers for storing media objects. It tracks buffer usage, has facilities for reusing previously allocated buffers, and can report memory statistics. As mentioned earlier, the global scheduler resides in the framework kernel 530 to manage the execution threads that traverse the processing graph network, keeping track of computational statistics such as mean latency and throughput.

The component library 520 is a continually growing collection of reusable components lying between the application and kernel. Rather than re-implementing common functionality (e.g., audio recording or image color-space conversion), the application developer may find useful, pre-built task objects from the reusable component library 520. Examples of prebuilt task objects include but are not limited to camera interfaces, graphics functionality, audio and video codecs, networking modules, etc. Leveraging the work of others is an important aspect of rapid development.

The final implementation layer is the application 510, such as a streaming media application, which has access to all previous layers. To promote further platform-independence, the application has access to all internal objects in any lower-level library created for the DM framework so that the DM network does not have to worry about those classes in the lower-library level implementing on different platforms. In the framework kernel 530, however, only the task and media abstractions are accessible in order to minimize the complexity of the DM framework interface. The internal objects are accessed indirectly through task and media objects or through static framework procedures.

According to one embodiment of the present invention, the DM framework has a number of distinguishing implementation features. First, there is a convenient mechanism for grouping input or output pins if it is known a priori that the data on those pins should always be associated together. For example, the combination module 440 of FIG. 4 will always operate on a pair of images. By placing the input pins in the same input group, the module begins operating only when both images have arrived, avoiding the need for the developer to manage and associate the input images. Because this association is known a priori, it is called static synchronization. Second, “fanout” from output pins of task modules are available, wherein an output pin of a task module may be input to multiple tasks. Thus, a media object output from one task module may be subsequently used by multiple other tasks. Furthermore, the output media may be read-only so that duplicate copies of the media object do not need to be made in the framework memory if the multiple other tasks do not need to modify the media object but merely employ it to perform other jobs. Thus, the same memory buffer containing the media object can be sent to all receiving task modules.

A third key implementation feature is automatic serialization. The Media base class has a powerful serialization procedure that can flatten any Media object, regardless of its complexity. Media objects can have both fixed-length fields (e.g., image size, format specification) and variable-length fields (e.g., image bytes, audio data). The serialization procedure is able to traverse any deep Media structure and translate it into a single flat buffer for output by the DM network to a serial representation, such as a file or network stream. Likewise, the automatic de-serialization procedure can read the flattened representation and translate it back into a deep Media structure in memory for processing by the DM network. Thus, the application developer need not be concerned with converting media objects into the proper format for processing by the DM network or converting back media objects after processing by the DM network in order to efficiently store such output media objects.

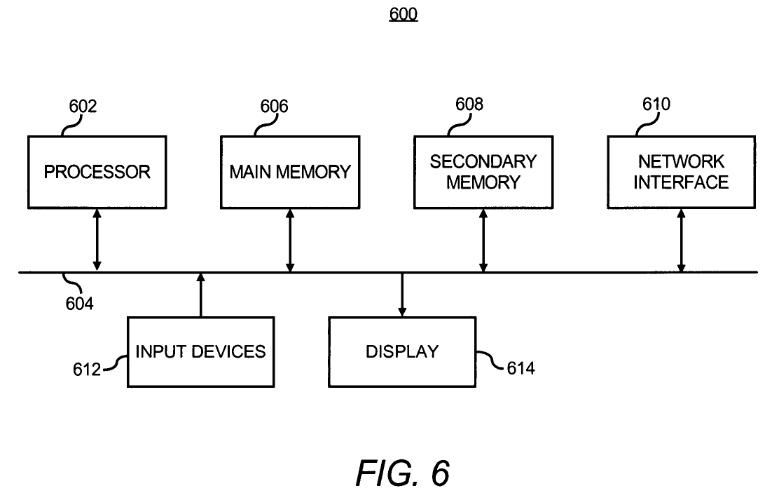

In one embodiment, the component library 520, the framework kernel 530, and the SMP abstraction layer 540 may be implemented by one or more software programs, applications, or modules having computer-executable programs that include code from any suitable computer-programming language, such as C, C++, C#, Java, or the like, which are executable by a computerized system, which includes a computer or a network of computers. Examples of a computerized system include but are not limited to one or more desktop computers, one or more laptop computers, one or more mainframe computers, one or more networked computers, one or more processor-based devices, or any similar types of systems and devices. FIG. 6 illustrates a block diagram of a computerized system 600 that is operable to be used as a platform for implementing the hierarchy 500 in FIG. 5. It should be understood that a more sophisticated computerized system is operable to be used. Furthermore, components may be added or removed from the computerized system 600 to provide the desired functionality.

The computer system 600 includes one or more processors, such as processor 602, providing an execution platform for executing software. Thus, the computerized system 600 includes one or more single-core or multi-core processors of any of a number of computer processors, such as processors from Intel, Motorola, AMD, and Cyrix. As referred herein, a computer processor may be a general-purpose processor, such as a central processing unit (CPU) or any other multi-purpose processor or microprocessor. A computer processor also may be a special-purpose processor, such as a graphics processing unit (GPU), an audio processor, a digital signal processor, or another processor dedicated for one or more processing purposes. Commands and data from the processor 602 are communicated over a communication bus 604. The computer system 600 also includes a main memory 606 where software is resident during runtime, and a secondary memory 608. The secondary memory 608 may also be a CRM that may be used to store the software programs, applications, or modules that implement one or more components of the hierarchy 500. The main memory 606 and secondary memory 608 each includes, for example, a hard disk drive and/or a removable storage drive representing a floppy diskette drive, a magnetic tape drive, a compact disk drive, etc., or a nonvolatile memory where a copy of the software is stored. In one example, the secondary memory 608 also includes ROM (read only memory), EPROM (erasable, programmable ROM), EEPROM (electrically erasable, programmable ROM), or any other electronic, optical, magnetic, or other storage or transmission device capable of providing a processor or processing unit with computer-readable instructions. The computer system 600 includes a display 614 and user interfaces comprising one or more input devices 612, such as a keyboard, a mouse, a stylus, and the like. However, the input devices 612 and the display 614 are optional. A network interface 610 is provided for communicating with other computer systems.

Alternative embodiments are contemplated wherein each of the components 520, 530, and 540 may be implemented in a separate computerized system, or wherein some of such components are executed by one computerized system and others are executed by another computerized system, or at least some of the task modules in the framework kernel 530 are executed by different computerized systems. Thus, the middleware framework may operate in a multiprocessing environment.

In summary, the application developer has the ability to specify the number of execution threads in the DM framework for maximal or most-desired parallelism. In one embodiment, the number of threads is set to equal the number of processors. In another embodiment, the number of threads is greater than the number of processors, especially when the threads can be blocked inside computation modules. However, during debugging of an application, it is extremely helpful to use a single execution thread so that it can easily be tracked.

What has been described and illustrated herein are embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for providing a middleware framework in a multiprocessing environment having multiple processing units for developing a desired application, comprising:
receiving a selection of a plurality of task modules for developing the desired application;
receiving connections between the selected task modules to form the desired application;
receiving an input of a plurality of execution threads for processing through the formed application; and
providing automatic global scheduling over the entire middleware framework of the plurality of execution threads by at least,
providing a job list of at least one job for execution by at least one of the plurality of execution threads, each of the at least one job is a processing of one or more data objects by an associated one of the selected task modules; and
automatically scheduling an execution of each job in the job list by one of the plurality of execution threads based on at least one predetermined policy.

2. The method of claim 1, further comprising:
receiving an input for creation of at least one task module for developing applications; and
wherein one of the selected task modules is the at least one created task module.

3. The method of claim 1, further comprising:
displaying a graph network representation of the formed application to show the selected task modules, the received connections between the task modules, and one of a throughput statistic and a latency of the formed application.

4. The method of claim 1, further comprising:
providing at least one predetermined task module in the middleware framework for developing applications; and
wherein at least one of the selected plurality of task modules is the at least one predetermined task module.

5. The method of claim 3, further comprising:
dynamically modifying a processing topology of the formed application based on receiving a user input modifying the graph network representation.

6. The method of claim 5, wherein dynamically modifying the processing topology of the formed application comprises:
maintaining internal states of the selected task modules in the formed application while modifying the processing topology of the formed application.

7. The method of claim 1, wherein the at least one job scheduled for execution by one of the plurality of execution threads includes a plurality of jobs, and the method further comprising:
based on the scheduling, the one execution threads automatically executing the plurality of jobs in at least two of the selected task modules and across at least two of the multiple processing units.

8. The method of claim 1, wherein the at least one predetermined policy is based on a priority indicator found in each of the one or more data objects associated with each of the jobs.

9. The method of claim 8, wherein the priority indicator of the each data object includes one of:
a) a time stamp of the each data object; and
b) a time stamp of an earliest data object of which the each data object is a descendant.

10. The method of claim 8, wherein the priority indicator of the each data object includes an identification of a data type of the each data object.

11. The method of claim 1, wherein the at least one predetermined policy is based on one of:
a) a type of task of one of the selected task modules associated with a job scheduled for execution in the job list;
b) an identification of one of the multiple processing units that is executing one of the plurality of execution threads;
c) an identification of one of the selected task modules that last performed a job in the job list; and
d) a determination that a job in the job list has available one or more of the data objects desired for the job to be performed.

12. The method of claim 1, further comprising:
executing the formed application based on the automatic global scheduling;
outputting a media object as a result of executing the formed application;
performing automatic serialization of the media object to translate the media object for a serial representation.

13. The method of claim 1, further comprising:
receiving a serial representation of a media object;
performing automatic deserialization of the serial presentation to translate the media object for execution by the desired application through the automatic global scheduling.

14. The method of claim 1, wherein the at least one predetermined policy is based on how many other of the selected task modules are dependent on an output of the selected task module that is associated with each of the jobs.

15. The method of claim 1, wherein providing the job list comprises:
dynamically generating each job in the job list in response to one of,
a) one of the selected task modules receiving at least one data object for processing; and
b) one of the selected task module is a source module desiring to generate at least one data object.

16. A middleware framework encoded as program code in a computer readable medium for developing a desired application on a multiprocessing platform having multiple processing units, the middleware framework comprising:
a framework kernel encoded as program code in the computer readable medium to generate task modules and media objects for building and running the desired application, the framework kernel including,
a global scheduler encoded as part of the program code for the framework kernel to provide automatic global scheduling for a plurality of execution threads over the entire middleware framework to process the generated media objects through the generated task modules based on a list of jobs maintained by the global scheduler and at least one predetermined policy, each of the jobs is a processing of one or more data objects by an associated one of the generated task modules; and
an abstraction layer encoded as program code in the computer readable medium to insulate the framework kernel from the multiprocessing platform to keep the framework kernel platform-independent.

17. The middleware framework of claim 16, wherein:
the global scheduler maintains a separate prioritization of the listed jobs for each of the plurality of execution threads.

18. The middleware framework of claim 16, wherein the number of the plurality of execution threads is different than one of the number of the generated task modules and the number of the multiple processing units in the multiprocessing platform.

19. The method of claim 1, further comprising:
automatically executing a job in the job list by one of the plurality of execution threads based on the automatic scheduling;
outputting from one of the selected task modules a media object in a memory buffer as a result of the automatic execution; and
providing the memory buffer as input to at least two other task modules of the selected task modules for executing at least two other jobs in the job list.

20. A computer readable medium on which is encoded program code for providing a middleware framework in a multiprocessing environment having multiple processing units for building a desired application, comprising:
program code for receiving a selection of a plurality of task modules for building the desired application;
program code for receiving connections between the selected task modules to form the desired application;
program code for receiving an input of a plurality of execution threads for processing through the formed application; and
program code for providing automatic global scheduling over the entire middleware framework of the plurality of execution threads by having at least,
program code for providing a job list of at least one job for execution by at least one of the plurality of execution threads, each of the at least one job is a processing of one or more data objects by an associated one of the selected task modules; and
program code for automatically scheduling an execution of each job in the job list by one of the plurality of execution threads based on at least one predetermined policy.
